(19) United States
(12) Patent Application Publication
(10) Pub. No.: US 2016/0223979 A1
(43) Pub. Date: Aug. 4, 2016

(54) CARTRIDGE, PROCESS CARTRIDGE, AND IMAGE FORMING APPARATUS

(71) Applicant: CANON KABUSHIKI KAISHA, Tokyo (JP)

(72) Inventors: Naoki Fukushima, Mishima-shi (JP); Atsushi Toda, Fuji-shi (JP); Taku Watanabe, Susono-shi (JP)

(21) Appl. No.: 15/009,050

(22) Filed: Jan. 28, 2016

(30) Foreign Application Priority Data
Jan. 30, 2015 (JP) 2015-017858
Jan. 30, 2015 (JP) 2015-017859

(51) Int. Cl. G03G 21/00

(52) U.S. Cl. CPC G03G 21/169; G03G 21/18

(57) ABSTRACT

A cartridge includes a cleaning member in contact with an image bearing member and that removes developer on the image bearing member, an accommodation chamber that accommodates the developer removed from the image bearing member with the cleaning member, and a conveying member provided immediately above the image bearing member in a gravitational direction and that conveys, from the accommodation chamber, the developer that has been removed. In the cartridge, a drive start time of the conveying member is late with respect to a drive start time of the image bearing member.

### BACKGROUND

1. Field of the Invention

The present disclosure relates to a cartridge, a process cartridge, and an image forming apparatus using the cartridge and the process cartridge.

2. Description of the Related Art

Typically, in an electrophotographic image forming apparatus (hereinafter, also referred to as an “image forming apparatus”), a drum-type electrophotographic photoconductor (hereinafter, also referred to as a “photosensitive drum”) is uniformly charged. Subsequently, an electrostatic latent image (an electrostatic image) is formed on the photosensitive drum by selectively exposing the charged photosensitive drum. The electrostatic latent image formed on the photosensitive drum is developed as a toner image with toner serving as the developer. Subsequently, the toner image formed on the photosensitive drum is transferred onto a recording material such as a recording sheet or a plastic sheet and, further, heat and pressure are applied to the toner image transferred on the recording material so as to fix the toner image on the recording material and to perform image recording.

Typically, such an image forming apparatus needs to have toner supplied thereto and maintenance to be performed on various process members thereof. A process cartridge that is detachable from an image forming apparatus main body is in practical use in which, in order to facilitate supply of toner and maintenance, a photosensitive drum, a charging device, a developing device, a cleaning device, and the like are formed into a cartridge inside a frame.

The process cartridge system allows the user to perform maintenance on the device; accordingly, operability is improved significantly such that an image forming apparatus with excellent usability can be provided. Accordingly, the process cartridge system is widely used in image forming apparatuses.

Furthermore, in the process cartridge described above, there are cases in which the toner collected from the surface of the photosensitive drum with the cleaning device needs to be conveyed to a position away from the collected position. As a member conveying the toner, a conveying member using a screw is known (Japanese Patent Laid-Open No. 10-312142).

However, when conveying the toner that has been collected with the cleaning device with the conveying member disposed above the photosensitive drum, a pressure of the toner accumulated in the cleaning frame is applied to the contact portion between the cleaning member and the photosensitive drum. In such a state, during the drive start time of the photosensitive drum when the cleaning ability is low, the toner and an external additive of the toner may disadvantageously pass the cleaning member.

### SUMMARY

The present disclosure provides a cartridge including a cleaning member in contact with an image bearing member and that removes developer on the image bearing member, an accommodation chamber that accommodates the developer removed from the image bearing member with the cleaning member, and a conveying member provided immediately above the image bearing member in a gravitational direction and that conveys, from the accommodation chamber, the developer that has been removed. In the cartridge, a drive start time of the conveying member is late with respect to a drive start time of the image bearing member.

Furthermore, the present disclosure provides a process cartridge and an image forming apparatus.

Further aspects of the present invention will become apparent from the following description of exemplary embodiments with reference to the attached drawings.

### BRIEF DESCRIPTION OF THE DRAWINGS

FIG. 1 is a cross-sectional view of an image forming apparatus main body and a process cartridge of an electrophotographic image forming apparatus according to a first exemplary embodiment.

FIG. 2 is a cross-sectional view of the process cartridge according to the first exemplary embodiment.

FIG. 3 is a cross-sectional view of an inside of a cleaner case of the process cartridge according to the first exemplary embodiment.

FIG. 4 is a diagram, according to the first exemplary embodiment, illustrating a change in a deformation state of a cleaning blade before and after a drum has been driven.

FIG. 5 is a conceptual drawing illustrating adhesion of a sensor when deformation of the cleaning blade is measured.

FIG. 6 is a diagram illustrating a shape of the conveying member according to the first exemplary embodiment.

FIGS. 7A and 7B are schematic diagrams of a cleaning portion of a third exemplary embodiment.

FIG. 8 is a schematic diagram of a cleaning portion of a comparative example.

FIG. 9 is a schematic diagram of the cleaning portion of the comparative example.

FIG. 10 is a schematic diagram of the cleaning portion of the comparative example.

FIG. 11 is a schematic diagram of the cleaning portion of the comparative example.

FIG. 12 is a driving time chart of the third exemplary embodiment.

FIG. 13 is a driving time chart of a modification.

FIG. 14 is a driving time chart of reference example.

### DESCRIPTION OF THE EMBODIMENTS

### First Exemplary Embodiment

Hereinafter, exemplary embodiments of the present disclosure will be described in detail with reference to the drawings.

Note that the rotational axial direction of the photosensitive drum serving as an image bearing member is the longitudinal direction.

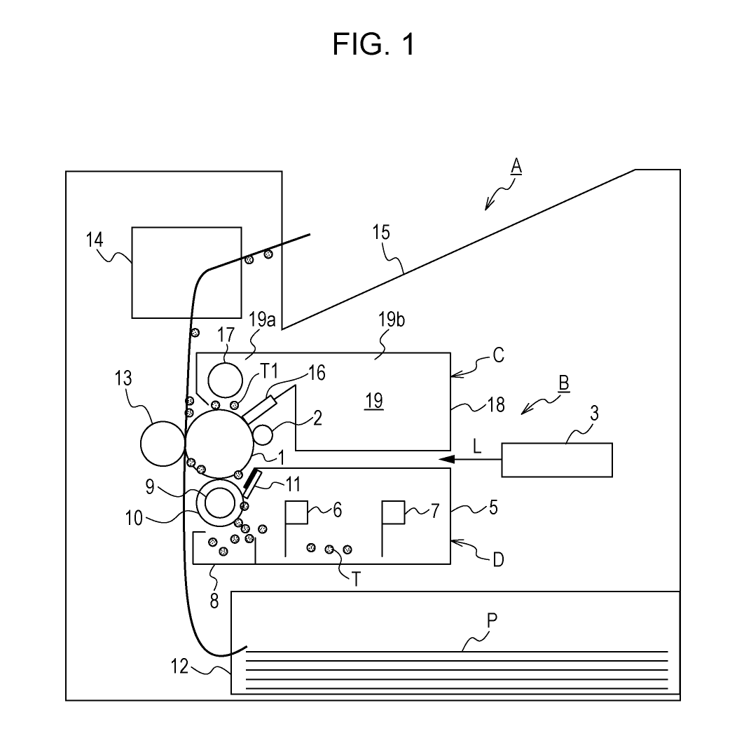

Referring to FIG. 1, an overall configuration and an image forming process will be described. FIG. 1 is a cross-sectional view of an image forming apparatus main body (hereinafter, described as an apparatus main body A) and a process cartridge (hereinafter, described as a cartridge B) of the electrophotographic image forming apparatus of an exemplary embodiment of the present disclosure.

Note that the apparatus main body A is the portion of the electrophotographic image forming apparatus excluding the cartridge B.

### (Image Forming Process)

An outline of the image forming process will be described next. As illustrated in FIG. 1, based on a print start signal, a photosensitive drum 1 (hereinafter, referred to as a drum 1) is rotationally driven at a predetermined circumferential velocity (process speed) in an arrow R direction. A charge roller 2 serving as a charging device to which a bias voltage is applied comes in contact with an outer peripheral surface of the drum 1, is driven by the drum 1, and charges the outer peripheral surface of the drum 1 in a uniform manner. An exposure device 3 outputs a laser beam L according to image information. The laser beam L scans and exposes the outer peripheral surface of the drum 1. With the above, an electrostatic latent image (an electrostatic image) according to the image information is formed on the outer peripheral surface of the drum 1.

Meanwhile, as illustrated in FIG. 1, in a development unit D serving as a development device, developer (hereinafter, referred to as toner T) in a toner chamber 5 is stirred and conveyed by a first conveying member 6 and a second conveying member 7 and is sent to a toner supply chamber 8. With the magnetic force of a magnet roller 9 (a stationary magnet), the toner T is carried on the surface of a developing roller (a developer bearing member) 10 serving as a developing sleeve. The toner T is triboelectrically charged with a developing blade 11 while the layer thickness of the toner T on a peripheral surface of the developing roller 10 is restricted.

The toner T developed on the drum 1 according to the electrostatic latent image turns into a visible image, that is, a toner image. Furthermore, as illustrated in FIG. 1, while matching the timing of the output of the laser beam L, a sheet material P that is a recording material sent out from a sheet tray 12 is conveyed to a transfer position between the drum 1 and a transfer roller 13. The toner image is sequentially transferred to the sheet material P form the drum 1 at the above transfer position.

The sheet material P on which the toner image has been transferred is separated from the drum 1 and is conveyed to a fixing device 14. Then, a compressing and heat fixing process is performed on the sheet material P passing through the fixing device 14 and the toner image is fixed to the sheet material P. The sheet material P that has undergone a fixing process of the toner image is discharged on a discharge tray 15.

Meanwhile, as illustrated in FIG. 1, the residual toner on the outer peripheral surface (on the image bearing member) of the drum 1 after the transfer is removed by a cleaning member 16 that is provided in a cleaning unit C serving as a cleaning device and is used once more in the image forming process. Waste toner T1 that has been removed from the drum 1 is accommodated in the accommodation chamber 19b. The toner accommodated in the accommodation chamber 19b is stored in a waste toner chamber 19a of the cleaning unit C with the screw 17 serving as a conveying member. In the present exemplary embodiment, the accommodation chamber 19, including the waste toner chamber 19a, is formed of a frame 18; however, there is a case in which the accommodation chamber 19b and the waste toner chamber 19a are separated with a partition wall. In such a case, the waste toner T1 is moved to an end portion of the conveying member in the axial direction with the conveying member, and the waste toner T1 is moved from the accommodation chamber 19b to the waste toner chamber 19a at the end portion. Then, when the waste toner T1 reaches the end portion of the waste toner chamber 19a, a screw of the like may move the waste toner T1 towards the middle of the waste toner chamber 19a.

In the present exemplary embodiment, the charge roller 2, the developing roller 10, the transfer roller 13, and the cleaning member 16 are the process members that act on the drum 1.

### (Overall Configuration of Cartridge)

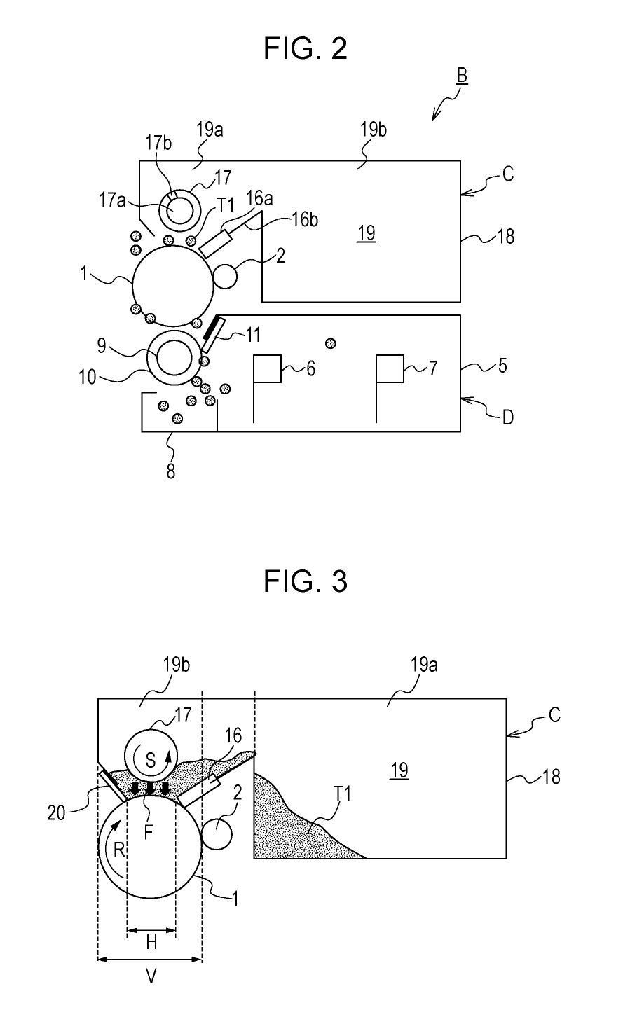

The overall configuration of the cartridge B will be described with reference to FIGS. 2 and 3. The cartridge B includes the cleaning unit C and the development unit D. In the present exemplary embodiment, although the cartridge is a combination of the cleaning unit C and the development unit D, the present disclosure is not limited to the above. The cleaning unit C itself may solely be the cleaning cartridge, for example.

As illustrated in FIG. 2, the development unit D includes the developing blade 11, the developing roller 10, the first conveying member 6, and the second conveying member 7. Furthermore, the developing roller 10, the first conveying member 6, and the second conveying member 7 are attached in a rotatable manner so as to be capable of transmitting, through gears (not shown), a drive from a driving source for development (not shown) in the image forming apparatus main body. Furthermore, the developing roller 10 is held by the frame so as to have a predetermined space from the drum 1 with space holding members (not shown) that are attached to the two end portions of the developing roller 10.

Meanwhile, as illustrated in FIGS. 2 and 3, the cleaning unit C includes the drum 1, the charge roller 2, the cleaning member 16, the screw 17 serving as the conveying member, and a drum abutting sheet 20. In the cleaning unit C, the charge roller 2, the cleaning member 16, and the drum abutting sheet 20 are each disposed so as to be in contact with the outer peripheral surface of the drum 1. Furthermore, as regards the positional relationship with the drum 1, the cleaning member 16 is, in the rotation direction of the drum 1, in contact with and is positioned 10° downstream of the uppermost portion of the drum 1 in the gravitational direction. Defining the above in another way, the contact portion in which the cleaning member 16 and the drum 1 come in contact with each other is, in the rotational direction of the drum 1, positioned on the downstream side with respect to a closest position that is where the surface of the drum 1 and the screw 17 are closest to each other. Note that a light incident position of the laser beam L is, in the vertical direction, below the contact portion in which the cleaning member 16 and the drum 1 come in contact with each other. Meanwhile, the drum abutting sheet 20 is in contact with the drum 1 at a position 10° upstream of the uppermost portion of the drum 1.

In the configuration of the present exemplary embodiment in FIG. 3, although the drum 1 rotates in the clockwise direction and the screw 17 rotates in the counterclockwise direction, the present disclosure is not limited to the above directions. For example, the screw 17 may, same as that of the drum 1, rotate in the clockwise direction.

As illustrated in FIG. 2, the cleaning member 16 includes a cleaning blade (a rubber blade) 16a that is a blade-shaped elastic member formed of rubber serving as an elastic material, and a support member 16b that supports the cleaning blade 16a. The cleaning member 16 abuts against the drum 1 in a direction countering the rotation direction of the drum 1. In other words, the cleaning blade 16a abuts against the drum 1 so that the tip of the cleaning blade 16a is oriented towards the upstream side with respect to the rotation direction of the drum 1. The angle formed at the contact position between the outer peripheral surface of the drum 1 and the cleaning blade 16a is 21°, and the cleaning blade 16a is disposed so that the nip width between the cleaning blade 16a and the outer peripheral surface of the drum is 1.0 mm. Furthermore, the drum 1 is rotatably attached such that the drive from a drum driving source (not shown) of the image forming apparatus main body is transmitted thereto through a drive gear, and the screw 17 is rotatably attached such that the drive from a driving source for conveyance is transmitted thereto through a drive gear.

Note that in the present exemplary embodiment, while there are two driving sources, namely, the driving source of the drum 1 and the driving source of the screw 17, the driving timing of the drum 1 and the screw 17 may be changed through switching a clutch or the like that changes the transmission timing of the drive from a single driving source. Furthermore, in the present exemplary embodiment, in order to reduce size, the drive for the screw 17 and the drive for the developing roller 10 are transmitted from the same driving source; however, the drive for the screw 17 and the drive for the developing roller 10 may be transmitted from a different driving source. Note that the driving source is the number of drive units on the apparatus main body side for transmitting the drive to the cartridge. The cartridge includes a driven unit that receives the drive from the drive unit. Drive from a plurality of driving sources means that the cartridge receives drive from a plurality of portions and that the cartridge includes a plurality of driven units.

### (Detail of Cleaning Portion)

Details of the portion in which cleaning is performed will be described next with reference to FIG. 3. FIG. 3 is a cross-sectional view of the configuration related to the cleaning of the cartridge B viewed in the longitudinal direction (the axial direction of the drum 1).

As illustrated in FIGS. 2 and 3, the drum 1 and the screw 17 are disposed so that the axes of rotation thereof are parallel to each other. The screw 17 includes a rotating shaft 17a and a spiral blade 17b that is provided on the outer side of the rotating shaft 17a (see FIG. 6). Furthermore, when viewed in the gravitational direction, the screw 17 is disposed immediately above the drum 1. Immediately above refers to the entire section of the screw 17 being disposed within the range in which the diameter of the drum 1 extends in the horizontal direction (an area V). Furthermore, the axis of the screw 17 is desirably disposed within an area H that is defined by the contact positions between the drum 1 and each of the drum abutting sheet 20 and the cleaning member 16. More desirably, the entire section of the screw 17 is disposed inside the area H.

The toner remaining on the surface of the drum 1 after the transfer passes the drum abutting sheet 20 and is scraped off from the drum 1 by the cleaning member 16. The waste toner T1 that has been scraped off by the cleaning member 16 is accumulated on the drum abutting sheet 20, the drum 1, and the cleaning member 16. When the upper surface of the accumulated waste toner T1 reaches a height that comes in contact with the screw 17, the waste toner T1 that has been accumulated is conveyed by the spiral blade 17b in the longitudinal direction with the rotation operation of the screw 17.

When driven, the screw 17 applies downward pressure F in the gravitational direction onto the waste toner T1 below the screw 17. The screw 17 being driven applies pressure to the waste toner T1 that is accumulated above the contact position between the drum 1 and the cleaning member 16; accordingly, the particle pressure of the toner in the area upstream of the contact portion between the drum 1 and the cleaning member 16 in the rotation direction of the drum 1 increases. On the other hand, the toner and an external additive that has been added to the toner tend to easily pass through the cleaning member 16 from directly after the drum 1 has started to drive until the drum 1 has rotated once, which is when the state of the cleaning member 16 is unstable. Accordingly, when the screw 17 is driven directly after the drum 1 is driven, the cleaning performance may be hindered. Accordingly, the drive start time of the screw 17, which is a conveying member, is set later than the drive start time of the drum 1. With the above, by not increasing the particle pressure of the toner and the like during when the cleaning performance of the cleaning member 16 is in an unstable state, passage of the particle matter becomes limited. In the present exemplary embodiment, in order to stabilize the cleaning state of the cleaning member 16, the drum 1 is rotated once after start of the drive of the drum 1; however the disclosure is not limited to rotating the drum 1 once but the drum 1 may be rotated more than once.

Effects of the present exemplary embodiment will be described next by comparing a comparative example and the first exemplary embodiment with each other. In the cleaning unit C of the present exemplary embodiment, a signal for starting the drive of the driving source for the drum 1 and a signal for starting the drive of the driving source for conveying are sent from a CPU serving as a control member. By shifting the transmission timings of the signals, the drive start time of the screw 17 is 0.2 sec delayed with respect to the drive start time of the drum 1. Conversely, in the comparative example, signals are transmitted by a CPU that serves as a control member so that the driving timings of the drum 1 and the screw 17 are the same. Herein, the time in which the control member transmits a drive start signal is the drive start time.

In the comparative example, since the screw 17 and the drum 1 start driving at the same time, the driving of the screw 17 is started while the behavior of the cleaning member 16 is unstable. During the formation of the image, after the toner on the drum 1 that has passed the transfer roller 13 is scraped off from the drum 1 with the cleaning member 16, a blocking layer, formed of external additive of the toner and the toner, is formed. The blocking layer is formed on the upstream side of the contact position between the drum 1 and the cleaning member 16 in the rotation direction of the drum 1. While the cleaning performance is improved with the formation of the blocking layer, upon start or stoppage of the drive that is the timing when the shape of the cleaning member 16 is deformed, the blocking layer tends to easily collapse due to application of an outer force. When the drive is started at the same time, the particle pressure of the toner in the vicinity of the blocking layer is increased by the screw 17 while the blocking layer is vulnerable to being collapsed; accordingly, a portion of the blocking layer collapses and the external additive or the toner forming the blocking layer passes the cleaning member 16. The external additive or the toner that has passed the cleaning member 16 becomes adhered to the charge roller 2 and causes a charging failure. The surface potential of the portion of the drum 1 where the charging failure has occurred changes causing a streak-like uneven density.

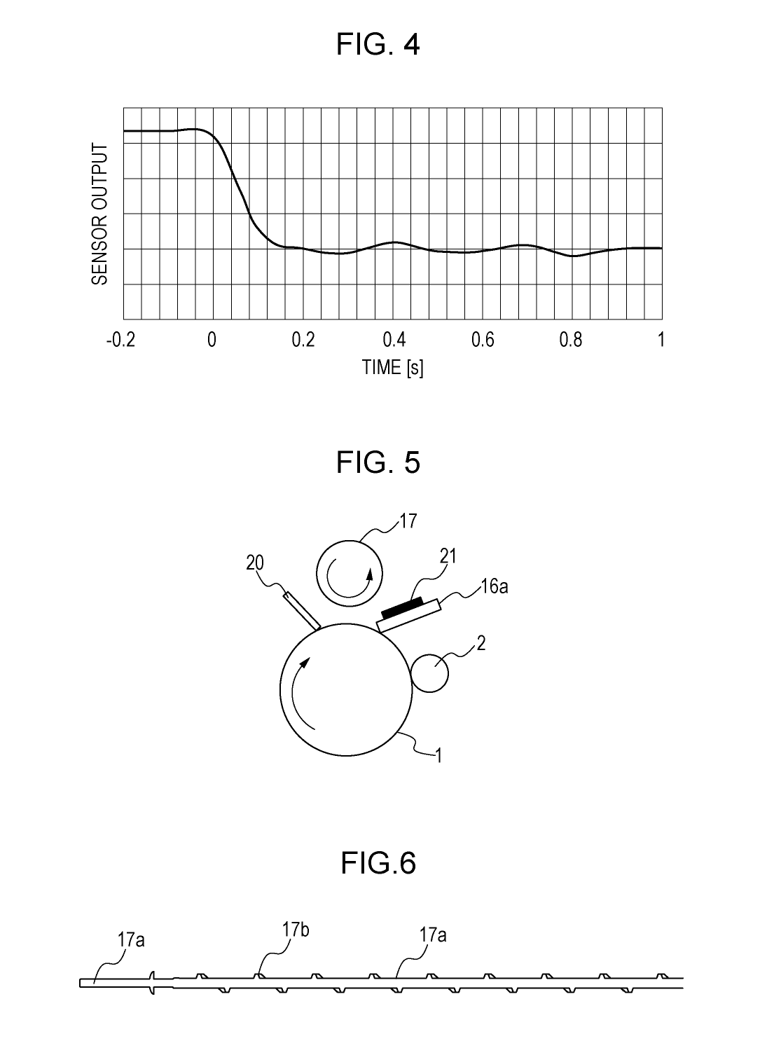

On the other hand, in the configuration of the first exemplary embodiment, the drive start timing of the screw 17 is delayed with respect to the drive start timing of the drum 1. Accordingly, the increase in the pressure of the toner caused by the screw 17 at the contact portion while the cleaning member 16 is deforming in an unstable state can be prevented and the cleaning performance can be improved. It is thought that the above is caused because, by driving the drum 1, the blocking layer is formed at the contact position between the cleaning member 16 and the drum 1 and in the portion upstream of the vicinity of the contact position. FIG. 4 is data showing the deformation of the cleaning member 16 before and after the start of the driving of the drum 1. As illustrated in FIG. 5, in the measurement of the deformation, a strain gauge 21 (manufactured by KYOWA, KFG-6-120-C1-11L3M3R) is adhered, with an adhesive, to the position opposite the cleaning blade 16a, which is a portion of the cleaning member 16, with respect to the screw 17. The amount of deformation of the cleaning blade 16a is measured by the amount of change in the output value of the strain gauge 21. In FIG. 4, the axis of abscissas is time and the axis of ordinates is the output value of the strain gauge 21, and at 0 seconds, the driving of the drum 1 is started. It can be understood from FIG. 4 that the cleaning blade 16a deforms greatly immediately after the drum 1 is driven, and the behavior of the cleaning blade 16a is stable 0.2 sec after the drum 1 has been driven.

Table 1 compares, between a comparative example and the first exemplary embodiment, the level of horizontal streaks on the image caused by dirt of the charging member.

TABLE 1

| | First Exemplary | |
|---|---|---|
| | Embodiment | Comparative Example |
| Horizontal Streak | NO | YES |
| on HT Image | | |

NO: no horizontal streak nor vertical streak has occurred.
YES: a horizontal streak or a vertical streak has occurred.

The conditions of the examination are as follows. In an environment having an ambient temperature of 15° C. and an ambient humidity of 10%, a half tone image with a printing ratio of 30% were printed onto 5000 sheets. Then, after 24 hours, a half tone image was printed once more and the level of the horizontal streaks was stated. Referring to Table 1, while horizontal streaks occurred in the comparative example, with the configuration of the first exemplary embodiment, the occurrence of the horizontal streaks due to faulty cleaning was improved.

As described above, by starting to drive the screw 17 after the drum 1 has started to drive, the pressure of the developer applied to the contact portion between the cleaning member and the image bearing member at the start of the drive of the image bearing member is reduced. A process cartridge with a high cleaning performance can be provided in the above manner.

Note that unless explicitly stated, the functions, the materials, the shapes, and the relative positions of the components of the present disclosure are not limited to those described in the present exemplary embodiment. Furthermore, any device that conveys toner is sufficient and the present disclosure is not limited to the process cartridge.

### Second Exemplary Embodiment

In the configuration of the first exemplary embodiment, while faulty cleaning is alleviated by delaying the drive start time of the screw 17 with respect to the drive start time of the drum 1, since the driving time of the screw 17 decreases, the waste toner T1 conveying performance may disadvantageously decrease. On the other hand, if the driving time of the screw 17 is increased to improve the waste toner T1 conveying performance, the driving time of the drum 1 increases and the life of the drum 1 decreases.

Accordingly, in the present embodiment, the drive start time of the screw 17 can be changed according to the differences in temperature and humidity. The above will be described by way of comparing the first exemplary embodiment and a second exemplary embodiment with each other.

In the configuration of the first exemplary embodiment, in an ambient temperature and an ambient humidity, the drive start time of the screw 17 is uniformly delayed by 0.2 sec with respect to the drive start time of the drum 1. Conversely, in the configuration of the second exemplary embodiment, the driving time of the drum 1 during formation of the image is not changed, and the drive start time of the screw 17 with respect to the drive start time of the drum 1 is delayed by 0.01 sec when in a high-temperature high-humidity environment and is delayed by 0.2 sec when in a low-temperature low-humidity environment.

In a high-temperature high-humidity environment, the chargeability of the waste toner T1 on the developing roller 10 becomes low; accordingly, the charge amount of the toner on the drum 1 is decreased and the transfer efficiency of the waste toner T1 to the transfer roller is reduced. With the decrease in the transfer efficiency, the amount of toner collected in the cleaning unit increases. Conversely, when the drive start time is late, since the conveying capacity of the screw 17 cannot catch up, the collected toner in the vicinity of the contact position between the cleaning member 16 and the drum 1 is brought to a consolidated state and the particle pressure may disadvantageously become high. In such a state, a portion of the blocking layer may collapse and the toner or the external additive may pass the contact portion between the cleaning member and the drum and a longitudinal portion of the cleaning member may be soiled by the toner or the external additive. As a result, the soiled portion may fail to become charged and may be manifested as a vertical streak on the image. On the other hand, in a high-temperature high-humidity environment, owing to the decrease in the rubber hardness of the cleaning member 16, the blade is more easily deformed according to the subtle unevenness of the surface of the drum 1 such that even when the blocking layer is in an unstable state at the start of the drive of the drum 1, compared with the low-temperature low-humidity environment, the cleaning performance is high. Accordingly, the passing of the toner or the external additive at the start of the drive of the drum 1 is alleviated.

As described above, as in the second exemplary embodiment, by increasing the driving time of the screw 17 when in a high-temperature high-humidity environment with respect to the driving time when in a low-temperature low-humidity environment, the waste toner T1 conveying performance is improved while maintaining the cleaning performance. Accordingly, increase in the particle pressure of the toner in the vicinity of the contact portion between the cleaning member 16 and the drum 1 can be reduced and occurrence of vertical streaks can be reduced.

Table 2 compares, between a first exemplary embodiment and the second exemplary embodiment, the level of the horizontal streaks on the image caused by dirt of the charging member and the vertical streaks.

TABLE 2

| | |
|---|---|
| First Exemplary | Second Exemplary |
| Embodiment | Embodiment |

| | | | | |
|---|---|---|---|---|
| Horizontal Streak | NO | NO | NO | NO |
| on HT Image | | | | |
| Vertical Streak | NO | YES | NO | NO |
| on HT Image | | | | |

NO: no horizontal streak nor vertical streak has been created.
YES: a horizontal streak or a vertical streak has been created.

The conditions of the examination are as follows. In an environment having an ambient temperature of 15° C. and an ambient humidity of 10%, and in an environment having an ambient temperature of 30° C. and an ambient humidity of 80%, a half tone image with a printing ratio of 30% were printed onto 5000 sheets. Then, after leaving the above for a long period of time, a half tone image was printed once more and the level of the horizontal streaks was examined. In the configuration of the first exemplary embodiment, in a low-temperature low-humidity environment, no streaks, that is, both the vertical streaks and the horizontal streaks, occurred on the image; however, in a high-temperature high-humidity environment, a vertical streak occurred. On the other hand, in the configuration of the second exemplary embodiment, in both environments, no vertical streaks and horizontal streaks occurred.

From the above, taking advantage of the fact that the cleaning performance and the transfer efficiency change according to temperature, by changing the time difference between the drive start time of the screw 17 and the drive start time of the drum 1, the cleaning unit can be used in a more efficient manner. Specifically, with respect to the drum 1 start time, by setting the drive start time of the screw 17 for a high-temperature high-humidity environment earlier than the drive start time of the screw 17 for a low-temperature low-humidity environment, the driving time of the screw 17 becomes longer and the toner conveying capacity becomes improved. As described above, by changing the difference in timing according to the ambient temperature and humidity, a favorable image in which no streaks occur can be obtained without increasing the driving time of the drum 1.

In the present exemplary embodiment, data is stored in a storage member so that the time difference between the drive start time of the drum and the drive start time of the screw can be varied within the range of 0.01 sec to 0.2 sec. Furthermore, on the basis of a signal according to information on the temperature and humidity from a temperature detection member, the CPU serving as a control member transmits a drive start time signal. In the present exemplary embodiment, the drive start time is shifted considering the temperature and the humidity; however, the drive start time may be shifted based on either one of the temperature and the humidity. For example, change control in which the time difference between the starting times at 25° C. or more is set shorter than the time difference between the starting times when under 25° C. may be performed. Furthermore, change control in which the time difference between the starting times at a humidity of 70% or more is set shorter than the time difference between the starting times when the humidity is under 70% may be performed. The temperature of 25° C. and the humidity of 70% are used for descriptions sake, and a predetermined threshold value may be set for the control.

Furthermore, the time difference between the drive start times and the control method are changed by the disposition of the conveying member, for example.

Furthermore, in the present exemplary embodiment, description has been given on the device that changes the drive start time of the screw while the drive start time of the drum are set the same. However, not limited to the above, depending on the design of the device, the drive start time of the drum may be changed and the time difference between the drive start time of the drum and the drive start time of the screw may be changed.

### Third Exemplary Embodiment

In the first and second exemplary embodiments, a configuration in which the drive start time of the screw is changed while having the drive start time of the drum serve as a reference has been described. However, the present disclosure is not limited to the above and the driving time of the image bearing member and the driving time of the conveying member may be changed as appropriate. Accordingly, as a third exemplary embodiment, description will be given on a configuration in which the driving time of the image bearing member is set longer than the driving time of the conveying member. Referring to the drawings, points different with the first exemplary embodiment and feature points of the third exemplary embodiment will be mainly described below.

### (Relationship Between Driving of Developing Roller and Driving of Drum)

Regarding the driving of the drum of the present exemplary embodiment, a photosensitive drum is rotationally driven by having the drive transmitted thereto from a drive motor of the image forming apparatus through a drive gear. Furthermore, the driving of the photosensitive drum includes driving the photosensitive drum for preparing image formation in each process of forming an image. Accordingly, among the components of the image forming apparatus, in most cases, the drum is driven for a long period of time. Note that the drive start time, the drive stop time, and the driving time are each based on the time the signal is transmitted from the control member (CPU or the like). Furthermore, the expression “drive” in the present exemplary embodiment refers to a drive that does not include the backlash caused by engagement of gears.

Furthermore, in the present exemplary embodiment, when the drum driving time of the present exemplary embodiment is long, scraping, scratches, and the like tend to be made on the photosensitive drum due to sliding friction with the other members; accordingly, in the present exemplary embodiment, the drum is set with a drive that is sufficient enough to form the image and with an appropriate drum driving time. Meanwhile, regarding the driving of the developing roller, the developing roller 10 is rotationally driven by having the drive transmitted thereto from a drive motor of the image forming apparatus through a drive gear. Note that a clutch that is capable of turning the transmission of the drive ON and OFF in the middle of the transmission of the drive from the apparatus main body is provided, and regardless of whether the drum is driven or not, the drive for development can be discretionarily driven or stopped.

The drive for development is required only before and after the latent image portion on the photosensitive drum is developed and the driving time for development can be shorter than the drum driving time. Accordingly, in the present exemplary embodiment, the driving time of the photosensitive drum is shorter than the driving time of the developing roller while the driving sufficient enough for development is at least performed. With the above, endurance of the developer can be increased while obtaining the drive required in the image forming process. The endurance of the developer can be increased because the occasion in which the developer in the developing device is rubbed against the other members of the development device can be reduced and the damage of the developer caused by sliding friction can be reduced.

(Relationship between Driving of Image Bearing Member, Driving of Conveying Member, and Driving of Screw)

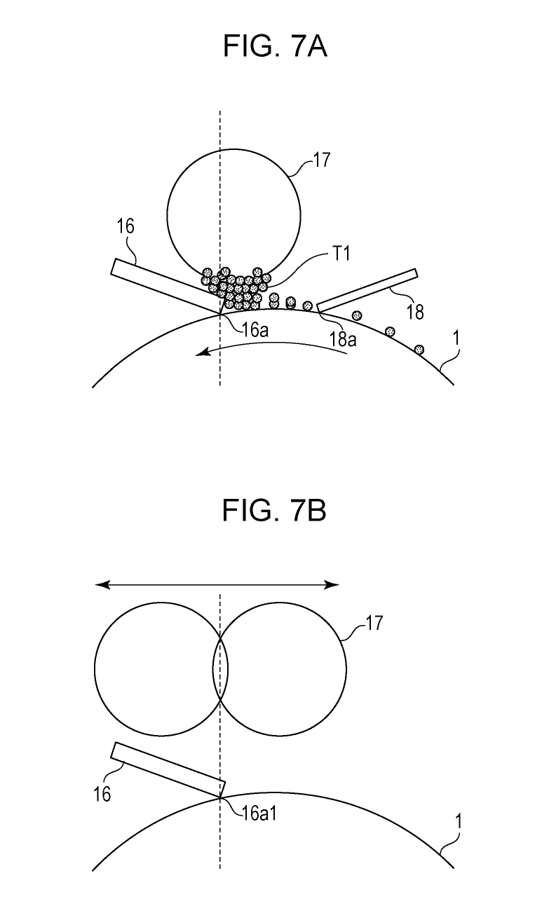

The conveyance of the waste toner T1 and the disposition of the screw 17 serving as the conveying member will be described next. FIG. 7A is a conceptual diagram around the screw 17. As in FIG. 7A, the toner is adhered on the photosensitive drum after the transfer. The adhered toner is, with the driving of the drum 1, scraped off by the contact portion 16a1 of the cleaning blade 16a and is collected as waste toner T1. Then the waste toner T1 collected from around the contact portion 16a1 accumulates in the accommodation chamber 19b. In the above case, when the accumulation amount is large, the cleaning blade 16a deforms by the weight of the waste toner T1; accordingly, in the present exemplary embodiment, the screw 17 is disposed immediately above the contact portion to reduce deformation.

Specifically, the screw 17 serving as the conveying member is disposed as in FIG. 7B. Although in FIG. 7B, the screw 17 is simplified and is illustrated as a circle, the screw 17 includes a shaft and a screw blade. Immediately above refers to a portion of the circle representing the screw 17 being disposed so as to overlap the vertical line (the broken line portion) passing through the contact portion 16a1 between the cleaning member 16 and the drum 1. In other words, the screw 17 is disposed so that when viewed in the axial direction of the screw 17, a straight line passing through the contact portion 16a1 crosses the section of the screw 17 (the circle). By disposing the screw 17 in the above manner, the screw 17 is disposed immediately above the contact portion 16a1. As regards the conveying direction of the waste toner T1 in the vicinity of the contact portion, the waste toner T1 in the screw area is conveyed in the longitudinal direction (a direction orthogonal to the drawing). The waste toner T1 is conveyed to the short direction towards the back side of the accommodation chamber 19b from the longitudinal end portion on the side in which the waste toner T1 had been conveyed.

Regarding the driving of the conveying member of the present exemplary embodiment, the screw is rotationally driven by having a drive transmitted thereto from a drive motor of the image forming apparatus through a drive gear. However, the clutch that can turn the drive transmitted from an intermediate drive gear ON and OFF exists. Accordingly, regardless of whether the drum 1, which is the drive of the image bearing member, is driven or not, the driving of the screw 17 can be discretionarily driven or stopped.

### Comparative Example

As a comparative example, a relationship between the cleaning blade 16a and the photosensitive drum 1 in a case in which, regarding the relationship between the drive of the drum and the drive of the screw, the driving times of the drum and the waste toner conveying screw are the same will be described.

In such a configuration, when in a state in which no toner is supplied to the photosensitive drum 1 (a state in which the drive for development is stopped), since the waste toner T1 having a lubricating effect is removed owing to the driving of the conveying screw, the cleaning blade may disadvantageously be turned over. The possibility of the cleaning blade being turned over will be described in detail while referring to the following flow from (1) to (4).

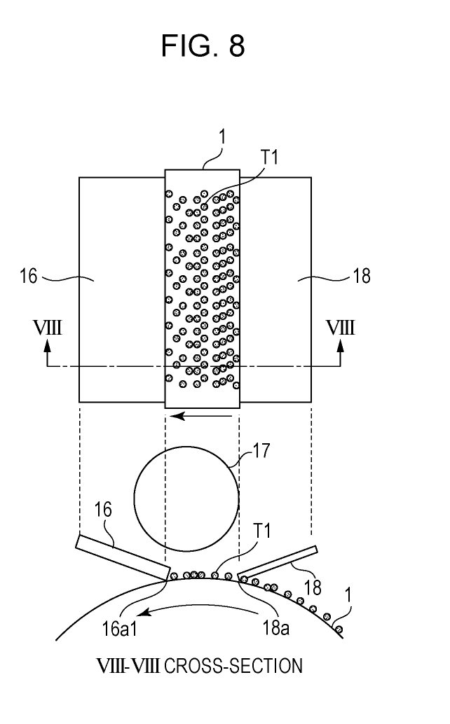

(1) As in FIG. 8, the waste toner T1 is collected by the photosensitive drum 1 and the cleaning blade 16a. Then, the drive for development is stopped and a state in which no toner is supplied is reached.

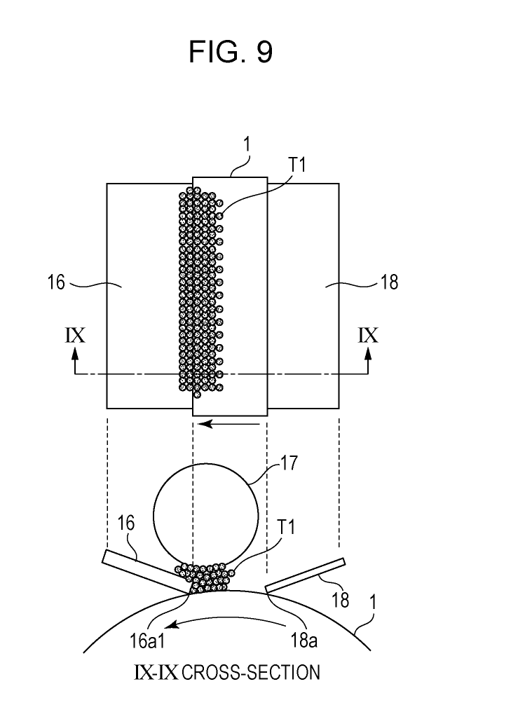

(2) As in FIG. 9, the waste toner T1 at the surface of the photosensitive drum 1, the contact portion 16a1 of the cleaning blade 16a, and the vicinity of the cleaning blade 16a receives conveying force in the accommodation chamber 19b with the drive of the photosensitive drum 1 in the arrow direction. The waste toner T1 moves along the surface of the photosensitive drum 1 from a collection start contact portion 18a (a collection start position) of the frame 18 of the cleaning unit C. Note that the conveying force of the surface of the photosensitive drum 1 varies in the longitudinal direction due to difference in the frictional resistance of the surface of the photosensitive drum 1 caused by discharge of charged electricity, sliding friction with the contact member, and the like.

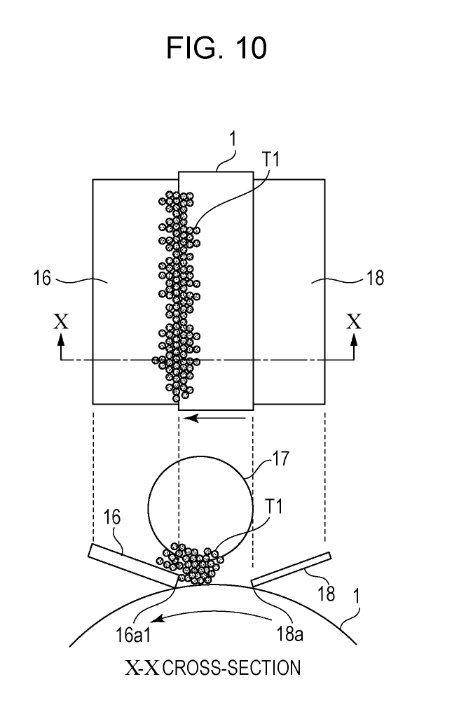

(3) As in FIG. 10, the waste toner T1 that has moved along the surface of the photosensitive drum 1 comes in contact with the cleaning blade edge, and the greater part of the waste toner T1 that does not pass the blade receiving the conveying force of the photosensitive drum 1 moves to the upper side of the blade edge. Subsequently, the waste toner T1 that has moved onto the upper portion forms a mountain-like shape immediately above the contact portion between the photosensitive drum and the cleaning blade. A portion of the above waste toner T1 collapses on the surface of the photosensitive drum 1 towards the collection start position of the accommodation chamber 19b and in the longitudinal direction. Subsequently, the waste toner T1 on the surface of the photosensitive drum 1 receives the drive of the drum and moves to the contact portion. A certain amount of the above waste toner T1 is interposed between the cleaning blade edge and the photosensitive drum 1 and serves as a waste toner T1 that has a lubricating effect; accordingly, a steady cleaning state is favorably maintained. Note that in the above, a portion of the waste toner T1 is in contact with the screw 17.

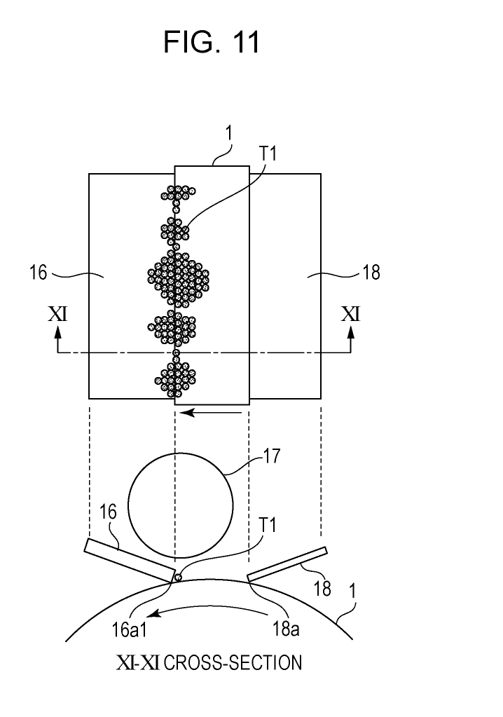

(4) However, when the driving times of the photosensitive drum 1 and the conveying screw 17 are the same, as illustrated in FIG. 11, the driving of the screw disadvantageously affects the distribution of the waste toner T1 at the contact portion and the vicinity of the contact portion. In other words, the conveying screw 17 excessively removes the waste toner T1 accumulated at the apex of the mountain-like shape. As a result, the toner moves from the portion where the amount of accumulated waste toner T1 is small to a portion where the amount of accumulated waste toner T1 is large such that the amount of accumulated waste toner T1 at the portion where the amount of accumulated waste toner T1 is small becomes further small. Accordingly, when viewing the contact portion and the vicinity of the contact portion in the longitudinal direction, portions where there are only an extremely small amount of waste toner T1 are disadvantageously created (localization of waste toner occurs). Due to the above, the lubricating effect of the waste toner T1 decreases and the possibility of the cleaning blade becoming turned over increases.

### Configuration of the Present Exemplary Embodiment

Accordingly, the driving time of the photosensitive drum 1 serving as the image bearing member is set shorter than the driving time of the screw 17 serving as the conveying member, and when the developing device (the developing roller 10) is driven (drive for development), the screw 17 is also driven.

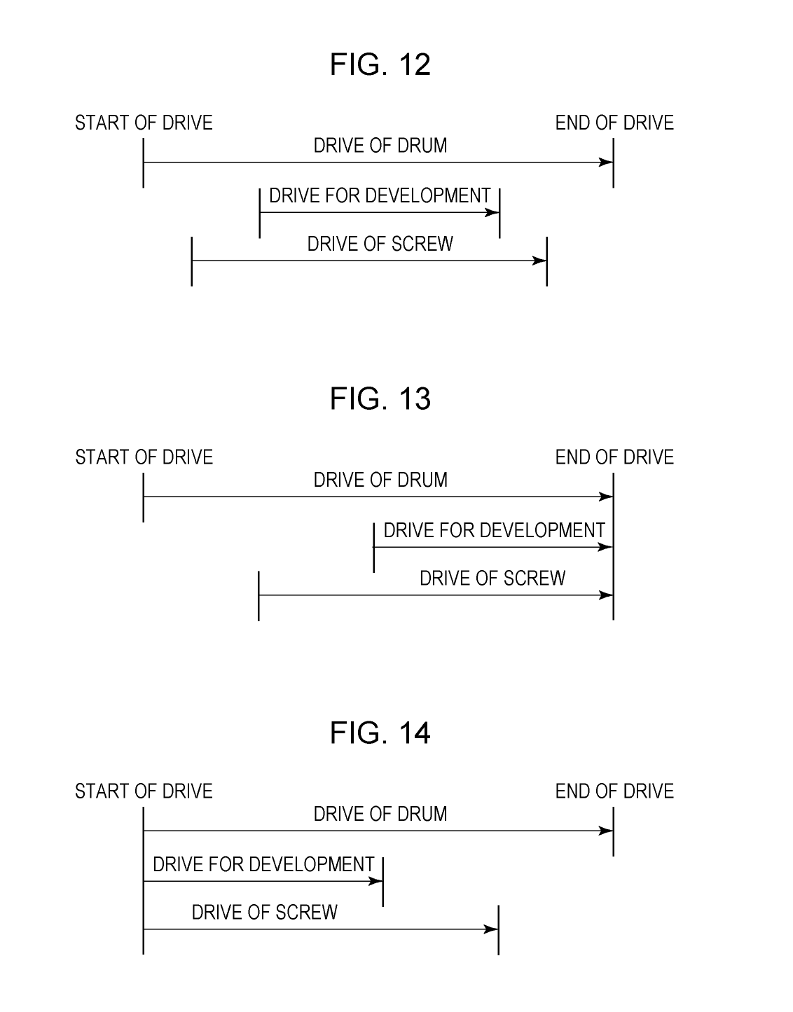

In FIG. 12, a time chart related to the specific driving times and driving timings of the present exemplary embodiment is illustrated. Note that the drive start time, the drive stop time, and the driving time are each based on the time the signal is transmitted from the control member (CPU or the like).

In the driving timings in FIG. 12, when image is formed, the photosensitive drum 1 first starts driving, and stops after 2000 msec of driving time. At a predetermined time from the drum drive start time, the driving of the screw 17 is started. The drive for development is started at a predetermined time after the screw drive start time. The driving time of the drive for development is 500 msec. In FIG. 12, while the screw drive start time and the development drive start time are different, the screw drive start time and the development drive start time may start the driving at the same time.

Among the driving times, the drum driving time is the longest and the driving times become shorter in the order of the screw driving time and the driving time for development. The screw driving time may be the same as the driving time for development. The screw 17 is to be driven at least during when the developing device is driven.

The stopping time of the driving of the drum is later than the stopping time of the drive for development and the stopping time of the drive of the screw. In FIG. 12, the stoppage of the drive for development is the earliest and the drive of the screw and the driving of the drum are stopped in this order. However, not limited to the above, the stoppage of the drive for development and the stoppage of the drive of the screw may be performed at the same time.

With the above configuration, effect of the weight of the waste toner T1 on the cleaning performance can be reduced. With the above, even if, during driving of the drum, the fogging toner is not supplied due to stoppage of the drive for development, a situation in which the screw excessively conveying the waste toner T1 causing waste toner T1 to become small in amount at the cleaning blade edge portion can be improved.

Accordingly, as in FIG. 10, a certain amount of waste toner T1 can be made to remain at the contact portion and the vicinity of the contact portion, and the risk of the cleaning blade becoming turned over can be reduced.

Furthermore, there may be cases in which a large amount of fogging toner suddenly comes into the cleaner case due to the drive for development. In such cases as well, since the driving time of the screw includes the driving time for development, excessive waste toner T1 can be conveyed before the waste toner T1 becomes overly excessive such that a sudden risk can be reduced.

Furthermore, in a case in which the screw driving time and the driving time for development are the same, a state in which the amount of waste toner T1 at the cleaning blade edge portion becomes small is created by the screw conveying the waste toner T1. At the same time, a state in which fogging toner is supplied and a certain amount of waste toner T1 remains at the edge portion is created. By having the two states occur at the same time, the risk of the cleaning blade becoming turned over can be further reduced.

Note that in the present exemplary embodiment, specific numerical values have been set forth for the driving times; however, as long as the order of the driving time is not changed, the driving times are not limited to the above numerical values.

### Advantages of Present Exemplary Embodiment Over Comparative Example

As in Table 3, the advantages of the present exemplary embodiment over the comparative example are the following points. First, the driving time of the screw is shorter than the driving time of the drum, and when the developing roller 10 is driven, the screw is driven. With the above, the damage of the developer caused by sliding friction can be reduced and the endurance of the developer is improved. Furthermore, in a development stopped state in which no fogging toner is supplied while the drum is driven, the start of the driving of the screw is delayed with respect to the driving of the drum. With the above, the waste toner T1 is not excessively conveyed from the contact portion and a certain amount of waste toner T1 having a lubricating effect can be interposed between the edge portion and the drum.

As described above, the present exemplary embodiment has an advantage in the endurance of the developer and the prevention of turning over of the cleaning blade.

TABLE 3

| | Reduction in | |
|---|---|---|
| | Damage of | |
| | Developer | Restraining |
| | Due to Sliding | Cleaning Blade |
| | Friction | from Turning over |
| Third Exemplary Embodiment | GOOD | GOOD |
| (Configuration: driving time of | | |
| screw is shorter than driving | | |
| time of drum, and screw is | | |
| driven while developing roller | | |
| is driven) | | |
| Comparative Example | POOR | POOR |
| (Configuration: driving time of | | |
| drum and driving time of screw | | |
| are the same) | | |

### MODIFICATION

A configuration of a modification will be described. Description of the portions that overlap the third exemplary embodiment will be omitted. The difference between the present modification and the third exemplary embodiment is that the stop timing of the drive of the screw, the drum drive stop timing, and the stop timing of the drive for development are the same.

In FIG. 13, a time chart related to the specific driving times and driving timings of the present modification is illustrated. As illustrated in FIG. 13, after formation of the image is completed, the photosensitive drum, the development, and the conveying member are stopped at the same time. In FIG. 13, the photosensitive drum starts to drive first and after 2000 msec, the drive of the photosensitive drum is stopped. Desirably, the screw driving time is the same or longer than the driving time for development. In FIG. 13, the screw driving time is 1000 msec and the driving time for development is 500 msec. The screw driving time is longer than 500 msec.

With the above, even if, during driving of the drum, the fogging toner is not supplied due to stoppage of the drive for development, a situation in which the screw conveying the waste toner T1 causing waste toner T1 to become small in amount at the cleaning blade edge portion can be improved.

Accordingly, the effect of the present modification is similar to the effect of the third exemplary embodiment, and in a development stop state in which no fogging toner is supplied while the drum is driven, a certain amount of waste toner T1 that has a lubricating effect can be interposed between the edge portion and the drum without having the drive of the screw excessively convey the waste toner T1 from the contact portion. Accordingly, the present modification is advantageous in the endurance of the developer and the prevention of turning of the cleaning blade and, accordingly, has an advantage over the comparative example.

### Reference Example

A configuration of a reference example will be described. Note that description of the portions that overlap the third exemplary embodiment will be omitted. The difference between the present reference example and the third exemplary embodiment is that the start timing of the drive of the screw, the drum drive start timing, and the start timing of the drive for development are the same.

In FIG. 14, a time chart related to the specific driving times and driving timings of the present reference example is illustrated. When forming an image, the photosensitive drum, the developing roller 10, and the conveying member are driven at the same time and the photosensitive drum stops driving after 2000 msec. Desirably, the screw driving time is the same or longer than the driving time for development. In FIG. 14, the driving time for development is 500 msec and the screw driving time is set longer than 500 msec. Accordingly, the drive of the screw stops after the drive for development has been stopped.

From the drive for development stop time to the screw drive stop time, the drum is driven and the drive for development is stopped such that no fogging toner is supplied. Even in such a state, the waste toner T1 is not excessively conveyed by the screw and a certain amount of waste toner T1 can be accumulated at the cleaning blade edge portion.

Accordingly, the effect of the present reference example is similar to the effect of the third exemplary embodiment, and in a development stop state in which no fogging toner is supplied while the drum is driven, the waste toner T1 is not excessively conveyed from the contact portion with the drive of the screw. With the above, the waste toner T1 having a lubricating effect can be interposed between the edge portion and the drum. On the other hand, since the screw is driven for a predetermined time, excessive accumulation of the waste toner T1 at the edge portion is prevented. Accordingly, the present reference example has an advantage in the endurance of the developer and the prevention of turning over of the cleaning blade.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-017858, filed Jan. 30, 2015 and No. 2015-017859, filed Jan. 30, 2015, which are hereby incorporated by reference herein in their entirety.

What is claimed is:

1. A cartridge comprising:
a cleaning member in contact with an image bearing member and that removes developer on the image bearing member;
an accommodation chamber that accommodates the developer removed from the image bearing member with the cleaning member; and
a conveying member provided immediately above the image bearing member in a gravitational direction that conveys, from the accommodation chamber, the developer that has been removed, wherein
a drive start time of the conveying member is late with respect to a drive start time of the image bearing member.

2. The cartridge according to claim 1, wherein
a contact portion in which the image bearing member and the cleaning member are in contact with each other is, in a rotation direction of the image bearing member, positioned downstream of the image bearing member where the conveying member and the image bearing member are closest to each other.

3. The cartridge according to claim 1, wherein
the drive start time of the conveying member is changed according to an ambient temperature.

4. The cartridge according to claim 1, wherein
the drive start time of the conveying member is changed according to an ambient humidity.

5. The cartridge according to claim 1, wherein
driving of the conveying member is started after the image bearing member has been rotated for a single turn or more from when the image bearing member has started to drive.

6. The cartridge according to claim 1, wherein
a time difference between the drive start time of the image bearing member and the drive start time of the conveying member is within a range of 0.01 seconds to 0.2 seconds.

7. The cartridge according to claim 1, wherein
an axial direction of the image bearing member and an axial direction of the conveying member are parallel to each other.

8. The cartridge according to claim 1, wherein
the conveying member is a screw.

9. The cartridge according to claim 1, wherein
the cleaning member includes a contact portion that is in contact with the image bearing member,
a conveying member that conveys the developer in the accommodation chamber is positioned immediately above the contact portion,
the driving time of the image bearing member is longer than the driving time of the conveying member, and
when a developer bearing member that develops an electrostatic image on the image bearing member is driven, the conveying member is driven as well.

10. The cartridge according to claim 9, wherein
a drive stop time of the conveying member is earlier than the drive stop time of the image bearing member.

11. The cartridge according to claim 9, wherein
a drive stop time of the conveying member is same as or later than a drive stop time of the developer bearing member.

12. The cartridge according to claim 9, wherein
a position of incident light emitted from an exposure member that expose the image bearing member is below the contact portion in a vertical direction.

13. The cartridge according to claim 9, wherein
the driving time of the conveying member is longer than a driving time of the developer bearing member.

14. The cartridge according to claim 9, wherein
the driving time of the conveying member and a driving time of the developer bearing member are equivalent to each other.

15. A process cartridge comprising:
an image bearing member;
a cleaning member in contact with an image bearing member and that removes developer on the image bearing member;
an accommodation chamber that accommodates the developer removed from the image bearing member with the cleaning member; and
a conveying member provided immediately above the image bearing member in a gravitational direction and that conveys, from the accommodation chamber, the developer that has been removed, wherein
a drive start time of the conveying member is late with respect to a drive start time of the image bearing member.

16. The process cartridge according to claim 15, wherein
the cleaning member includes a contact portion that is in contact with the image bearing member,
a conveying member that conveys the developer in the accommodation chamber is positioned immediately above the contact portion,
a driving time of the image bearing member is longer than a driving time of the conveying member, and
when a developer bearing member that develops an electrostatic image on the image bearing member is driven, the conveying member is driven as well.

17. An image forming apparatus that forms an image on a recording material, comprising:
an image bearing member;
an image development unit that develops a latent image formed on the image bearing member with developer;
a cleaning member in contact with the image bearing member and that removes developer on the image bearing member;
an accommodation chamber that accommodates the developer removed from the image bearing member with the cleaning member; and
a conveying member provided immediately above the image bearing member in a gravitational direction and that conveys, from the accommodation chamber, the developer that has been removed, wherein
a drive start time of the conveying member is late with respect to a drive start time of the image bearing member.

18. The image forming apparatus according to claim 17, wherein
the cleaning member includes a contact portion that is in contact with the image bearing member,
the conveying member that conveys the developer in the accommodation chamber is positioned immediately above the contact portion,
a driving time of the image bearing member is longer than a driving time of the conveying member, and
when a developer bearing member that develops an electrostatic image on the image bearing member is driven, the conveying member is driven as well.
